(19) United States
(12) Patent Application Publication
(10) Pub. No.: US 2002/0144483 A1
(43) Pub. Date: Oct. 10, 2002

(54) Energy screen kits for window insulation

(76) Inventor: Mark Shippen, Prattville, AL (US)

Correspondence Address: Mark Shippen, 108 St. Francis PI, Prattville, AL, 36066, US

(21) Appl. No.: 09/828,609

(22) Filed: Apr. 9, 2001

(51) Int. Cl. E06B 3/00; E06B 7/00; E04C 2/38

(52) U.S. Cl. 52/656.1; 52/656.7; 52/656.9; 52/656.5; 52/204.593

(57) ABSTRACT

Analogous to a bug screen for windows, an Energy Screen is a rigid frame covered with two clear films of plastic which is applied fittingly to the interior of a window. This will conserve the heating and cooling load of a house by as much as 42%. An easy to assemble kit is disclosed which does not require sawing rigid members, but installs with scissors as the only tool.

### BACKGROUND AND SUMMARY OF THE INVENTION

The Earth's natural resources are precious and provide for our survival. Among these resources are the fossil fuels we burn to power our great cities and to warm our homes. As a result of an enormous energy demand, we have created problems like excessive sulfur dioxide emissions, carbon dioxide emissions, catastrophic oil spills, power brown-outs, and nuclear waste. What, then, can we do to minimize these problems ? The most direct way is to implement energy conservation projects.

This patent disclosure details a unique, effective, and valuable invention to conserve energy lost through windows. Moreover, the energy that can be conserved is the energy necessary to maintain comfortable climates in homes and buildings. Not only can great amounts of energy be conserved with this invention, but auxiliary components such as mechanical furnace heaters and air conditioners will last longer with the substantial reduction in cyclical usage. Since the energy consumption in the United States alone exceeds 40 billion dollars annually for residential heating and cooling, there is a substantial economic gain to be made with this invention.

Specifically, an Energy Screen provides an optically clear means to insulate a window, thereby drastically reducing the heat transfer through the window. In the U.S., the architectural trend over the last 120 years has been to increase the window space in homes. Now, the energy lost through the windows approaches the energy lost through air changes in the entire house. This fact makes the energy screen the best invention to conserve energy in a house.

To derive maximum energy savings, this invention must be user friendly, easy to construct, optically clear, and pull out from the window easily. This invention is designed to be installed interiorly, so the user has easy access. The first requirement of this invention is a rigid frame that is easy to construct and must have ¼ inch clearance from the window recess. The frame must be rigid enough to have two layers of plastic film adhered to the frame and not bend or distort under small tension from the stretching or shrinking of the plastic. An easy to apply gasket will surround the perimeter of the frame. This gasket can be as simple as the 1 inch over coverage of the frame with the plastic films. Such a design will seal the energy screen within the window frame to create multiple dead air spaces, the condition required for good window insulation.

Theoretically, an Energy Screen will give the user additional insulation value comparable to a double pane window addition. Therefore, a 67% reduction in heat transfer is projected for single pane windows. If double pane windows are insulated with an Energy Screen, a 50% reduction in heat transfer is predicted. Given the great energy savings potential, its user friendly characteristics, and its optical clarity, this invention will be used in high demand.

### DESCRIPTION OF THE PRIOR ART

In the past plastic films including vinyl, polyethylene, and heat shrink films have been tacked, taped, or affixed to a window frame. Customarily, these applications are disposable. If a good seal is obtained and no edge losses are assumed, a 1R insulation value is obtained. This new invention will get twice the insulation value of the old applications. Furthermore, reflective films and coatings may be applied to glass to reduce the summer cooling load. Unfortunately, these applications work against the wintertime heating load. Now this new invention will work year round for maximum energy savings.

A costly alternative product is the storm window. These glass windows are effective energy savers, but cost much more than an Energy Screen. Energy Screens are much easier to install. Also, low emissitivity glass has been used. This technology is priced too high for widespread acceptance. Currently, it is not feasible to retrofit existing windows.

U.S. Pat. No. 5,108,811 discloses a non optically clear window insulation. Most customers, however, prefer the optically clear Energy Screen.

### ADVANTAGES

This invention will allow the user to fabricate their own custom fit window insulation. Kits can be sold for each window. The user can pull the interiorly fit Energy Screen out easily to open the window. Reinstallation is simple. A feature such as specifying the gasket as an 1 inch overlapping of the plastic film will further simplify the invention. Also, if the rigid frame is specified with sliding fit members, the user will not have to saw the rigid frame to make an exact fit for the window. Packaging and shipping the Energy Screen Kits will require smaller, more easy to handle, and less easy to damage, boxes.

### DESCRIPTION OF THE DRAWINGS

FIG. 1 is a complete overview of an Energy Screen.

FIG. 2 is a hollow corner connection.

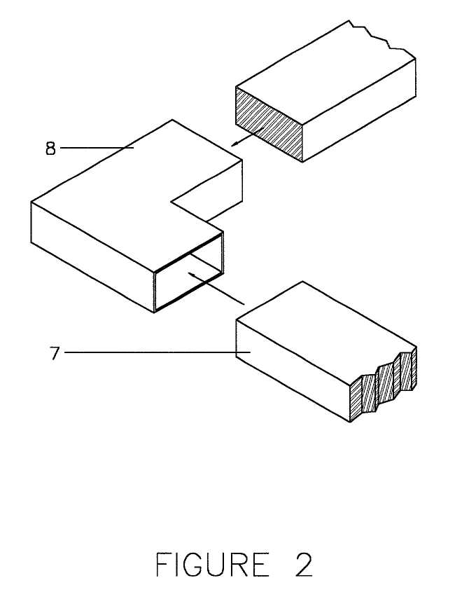

FIG. 3 is a wood corner connection drilled to fit a wood screw.

FIG. 4 is an aluminum H -clip used as a corner connection.

FIG. 5 is a solid corner connection.

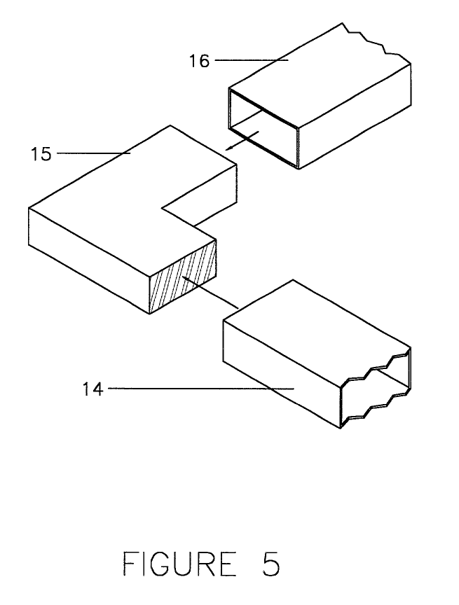

FIG. 6 is an aluminum C-channel drilled to fit drilled holes in a melamine frame.

FIG. 7 is an adjustable rigid frame with slip fit members.

FIG. 8 is an overview of an Energy Screen where overlapping plastic films form a self-sealing gasket.

### LISTING OF THE DRAWING REFERENCES

1) Rigid frame.

2) Plastic film.

3) Foam gasket.

4) Corner connection.

5) Double sided adhesive tape.

6) Pull-out knob.

7) Solid rigid member.

8) Hollow corner connection.

9) Wood screw.

10) Drilled screw starter hole.

11) Wood rigid frame member.

12) Aluminum H-clip.

13) Rigid frame material.

14) Hollow rigid frame member.

15) Solid corner connection.

16) Hollow rigid frame member.

17) Wood screw.

18) Aluminum C-channel.

19) Melamine rigid frame member.

20) Corner connection.

21) Hollow tube rigid frame member.

22) Solid tube rigid frame member that will insert into 21 snugly.

### DESCRIPTION OF THE PREFERRED EMBODIMENTS

The embodiments of this invention include the following elements:

1) Rigid frame members.

2) Corner connections.

3) Double sided adhesive tape.

4) Double plastic films.

5) A gasket

6) A pull-out knob.

Embodiment 1 consists of rigid members that can be connected to form a frame.

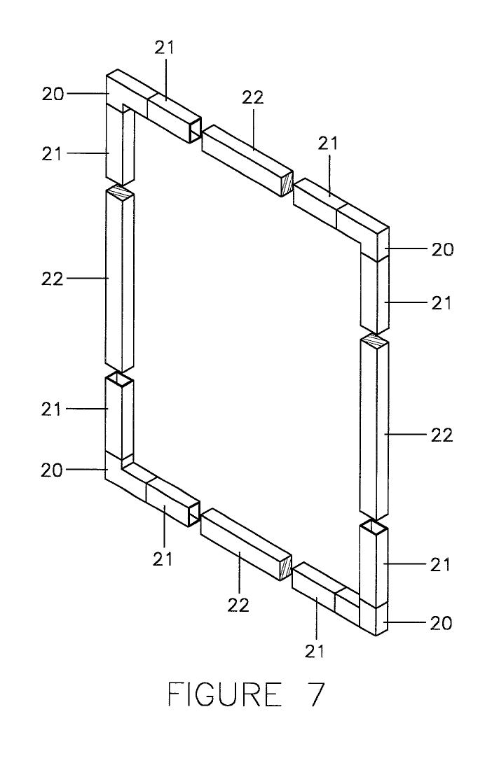

Materials suitable for a rigid frame include 7) metal, wood, plastic and melamine. These materials are solid. In contrast, 14) includes hollow rigid members made of aluminum, or extruded plastic. FIG. 7 shows how both solid and hollow rigid members can slide together to form an adjustable frame. Member 21), a hollow piece, slides into the corner piece and member 22), a solid piece, slides into member 21) on both ends. The advantage of a self sizing rigid frame means the user will not have to saw through a rigid member and smaller pieces make boxing and shipping easier.

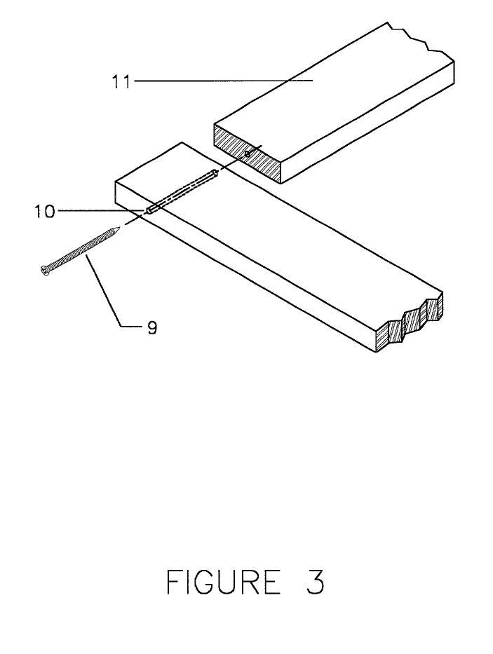

The corner pieces, Embodiment 2, connect the rigid frame members together. A corner joint can be made as simple as drilling a starter hole through wood ½×¾ inch and threading a wood screw through it. See FIG. 3.

Injection molded corner pieces can be manufactured hollow 8) to accept solid rigid members or manufactured solid 15) to accept hollow rigid members. Currently, Elgar Products Inc. of Cleveland, Ohio sells a line of bug screening materials including solid corner pieces which slip fit into hollow aluminum framing material. These materials are acceptable for making interior fitting Energy Screens. However, to make a self adjustable frame, a solid steel, aluminum, or plastic members will be required to slip fit into Elgar's hollow aluminum framing material. See FIG. 7.

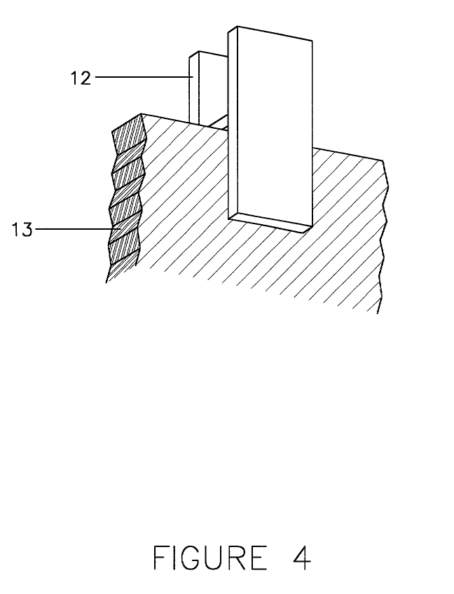

Other corner possibilities include aluminum H-clips 12) which when used in conjunction with an epoxy composition will make a tight fit with melamine 13). See FIG. 4.

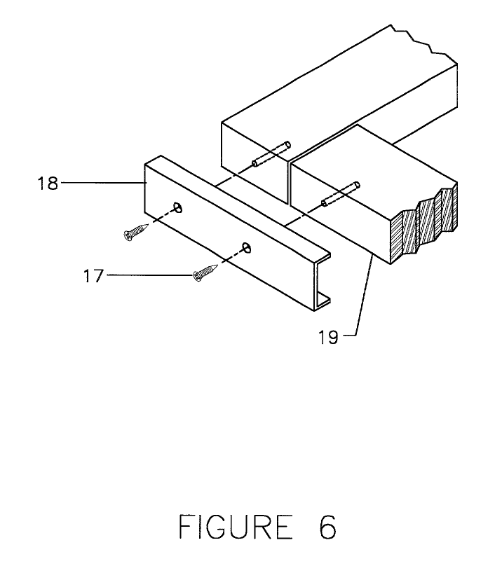

Another corner possibility includes a 4 inch long by ½ inch aluminum C-channel 18) piece with two drilled holes. This piece will hold the conjunction of two ½ inch thick by 2 inch wide melamine rigid members 19). Two starter holes will have to be made to accept two wood screws 17). See FIG. 6.

Not shown in the drawings are various right angle braces and hardware that can be used to join wood and melamine.

Embodiment 3 specifies a double sided adhesive tape that will adhere the plastic films to both sides of the frame 5). Once the frame has been sized to fit the particular window, the tape can be applied in four pieces around both sides of the frame.

Embodiment 4 requires two plastic films. The best material is a heat shrinkable film that can be hand fitted onto the frame 2). Most all the wrinkles in the plastic films can be smoothed out by careful placement. If necessary, the heat from a hot hair dryer will eliminate remaining wrinkles.

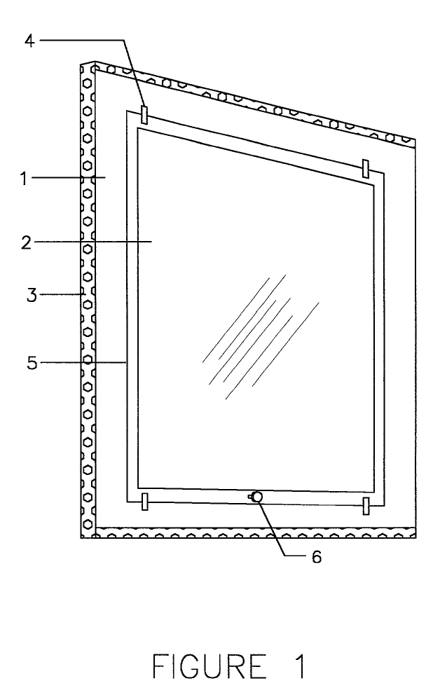

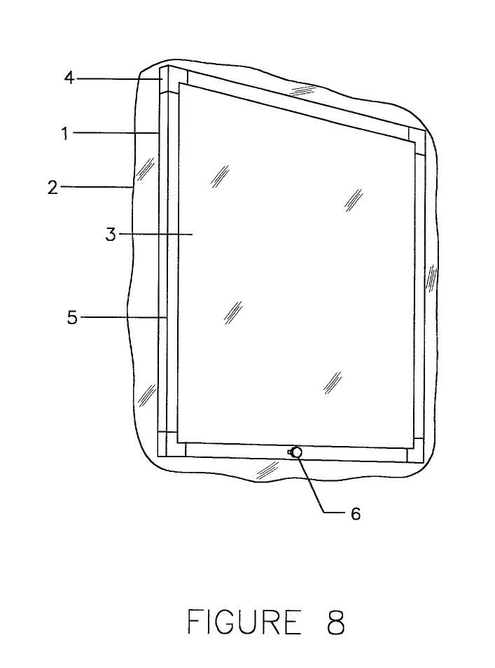

Embodiment 5 is the gasket 3). See FIGS. 1 and 8. The gasket can be made from closed cell foam material or by enclosing open cell foams with ½ mil polyethylene. Polyethlene, polyurethane, or sponge rubber can form a suitable gasket material. Preferably, a 1 inch overlapping of the plastic films with the frame will make a good seal and can act as the gasket. See FIG. 8. This will substantially reduce the cost and complexity of an Energy Screen. The user can feel by hand around the gasket to insure good sealing on a cold day.

Finally, a pull-out knob 6) can be affixed to the bottom member of the rigid frame. A hole can be drilled and a cabinet hardware knob screwed into place for easy removal of the Energy Screen. Alternatively, for convenience, two knobs can be screw fitted on the bottom corner pieces of the invention.

### CONCLUSIONS

In his book, Movable Insulation, Langdon reports a 42% savings in the overall heating load for 2R of added window insulation. Clearly, significant energy savings are anticipated for Energy Screens. Although Langdon's experimental models were non optically clear, this means insulation must be removed during daylight hours to realize solar energy gains. The present invention is a vast improvement. Now, movable insulation technology is passive. Even more energy savings can be expected.

In summation, an easy to assemble Energy Screen Kit can conserve vast amounts of energy. Now, optically clear films will make the applied kit unnoticeable to users. Little or no reluctance to install these kits should be expected. With the national energy consumption exceeding 40 billion dollars each year to cool and heat residences, this invention should sell well. The great energy savings realized with this invention will conserve fossil fuels and minimize problems associated with their aggressive use. The inventor will benefit, the user will save on utility bills, the utilities will produce less pollution, and everyone in the world will benefit from a cleaner environment.

What I claim:

1) An article of window insulation comprising:
A) Rigid frame members,
B) Four corner connectors forming a rigid frame with said rigid frame members,
C) Double sided adhesive tape applied to both sides of said rigid frame,
D) Dual plastic films applied in tension to said rigid frame,
E) A gasket applied to the perimeter of said rigid frame,
F) A pull-out knob attached to said rigid frame member or said corner connectors.

2) The article of window insulation of claim 1 wherein the rigid frame members are either metal, plastic, wood, or melamine.

3) The article of window insulation of claim 1 wherein said rigid frame members slip-fit into each other.

4) The article of window insulation of claim 1 wherein said corner connections are hollow plastic, solid plastic, metal, H-clips, wood screws, C-channel, or right angle hardware.

5) The article of window insulation of claim 1 wherein the plastic film is either polyethylene, vinyl, or heat shrinkable film.

6) The article of window insulation of claim 1 wherein the gasket consists of polyethylene, polyurethane, sponge rubber, or overlapping film from said dual plastic films.

7) A window insulation kit comprising
A) Rigid frame members,
B) Four corner connectors forming a rigid frame with said rigid members,
C) Double sided adhesive tape applied to both sides of said rigid frame,
D) Dual plastic films,
E) A gasket,
F) A pull-out knob(s).

8) The window insulation kit of claim 7 wherein the rigid frame members are either metal, plastic, wood, or melamine.

9) The window insulation kit of claim 7 wherein said rigid frame members slip-fit into each other.

10) The window insulation kit of claim 7 wherein said corner connections are hollow plastic, solid plastic, metal, H-clips, wood screws, C-channel, or right angle hardware.

11) The window insulation kit of claim 7 wherein the plastic film is either polyethylene, vinyl, or heat shrinkable film.

12) The window insulation kit of claim 7 wherein the gasket consists of polyethylene, polyurethane, sponge rubber, or overlapping film from said dual plastic films.
